(19) United States
(12) Patent Application Publication
(10) Pub. No.: US 2003/0102970 A1
(43) Pub. Date: Jun. 5, 2003

(54) Tool or implement storage system using wireless devices to facilitate tool control

(76) Inventors: Myron Dale Creel, Panama City, FL (US); Adelaide Laura Whittington, Panama City, FL (US); Christopher Adam Creel, Auburn, AL (US)

Correspondence Address: Pennington, Moore, Wilkinson, Bell & Dunbar, P.A., P. O. Box 10095, Tallahassee, FL, 32302-2095, US

(21) Appl. No.: 10/295,090

(22) Filed: Nov. 15, 2002

Related U.S. Application Data
(60) Provisional application No. 60/335,745, filed on Nov. 15, 2001.

(51) Int. Cl. G08B 13/14; G08B 21/00

(52) U.S. Cl. 340/568.1; 340/572.1

(57) ABSTRACT

An improved storage enclosure with the ability to query individual objects within the enclosure in order to verify the presence or absence of each object. It also possesses the capability of wirelessly transmitting this verification information to a central control unit for further processing and maintenance coordination. The proper recording of these verifications will provide increased security against the likelihood of adverse incidents resulting from misplaced objects such as tools. In addition, the storage enclosure may be programmed to report its position, based on proximity to vehicles or other objects having a known position.

### STATEMENT REGARDING FEDERALLY SPONSORED RESEARCH OR DEVELOPMENT

Not Applicable.

### MICROFICHE APPENDIX

Not Applicable.

### BACKGROUND OF THE INVENTION

1. Field of the Invention

This invention relates to the field of object location management. More specifically, the invention comprises an enclosure and accompanying electronic devices capable of determining whether certain objects are contained within the enclosure, and providing information to a user regarding the presence or absence of said objects.

2. Description of the Related Art

The use of hand tools, especially in the aviation and vehicle maintenance industries, requires portable storage of hundreds of individual tools. Such tools are typically housed in portable toolboxes which must be carried from a central storage location to the work site. As each of the tools is used in and around an aircraft or vehicle, the inevitable misplacement of the tools occurs, resulting not only in loss of the tools themselves but, far more importantly, the possibility of Foreign Object Damage (FOD) to the vehicle. Entire aircraft have been lost to mishaps that occurred after a loose tool found its way to a vulnerable location in the collective mechanism of a moving vehicle or engine. Also, intentional theft of tools has always been a financial drain on government and commercial resources. More sinister yet, a tool could be purposely hidden inside a vehicle to accomplish sabotage.

The United States military and the civilian airline industry have taken measures for many years to reduce the likelihood of misplaced tools being left aboard vehicles during maintenance activities. One of the earliest concepts applied to the problem was the Consolidated Tool Kit, or “CTK.” The CTK consists, in its simplest form, of a portable toolbox having a specific list and quantity of tools contained therein. The CTK is dispensed from a central location to a specific individual in exchange for a tag or other method of registration to the individual in possession of the toolbox. The person in charge of the central location is usually charged with verifying the completeness of the kit upon its return.

The CTK concept is further enhanced by the installation of foam or other material in the drawers, having silhouettes cut out in the shape of the individual tools, as well as engraved markings on the tools, to provide easy identification of missing items. FIG. 4 shows a toolbox drawer having a foam drawer liner 13. Each tool housed in this drawer has a unique receptacle slot. If a tool is absent, a simple visual inspection will reveal this fact.

At best, a missing tool in a CTK necessitates the search of all vehicles on which maintenance was performed by that technician, in order for the missing item to be found before it results in Foreign Object Damage and/or subsequent loss of the vehicle. It is possible, however, for less conscientious individuals or groups, under the pressure of flight or other operational schedules, to substitute a like item in the CTK in order to avoid delay or discipline over the missing tool. Thus, the existing system is susceptible to human error or outright deception.

Even when there is no deceptive intent, the verification delay present in the existing system causes problems. When a technician finishes working on one vehicle, he or she may take the CTK over to a second vehicle to begin a new job. The CTK is typically not returned to the inventory authority (the tool supply attendant) until the end of the work shift. Personnel within the inventory authority then typically inspect the CTK and note any missing tools. If a tool is found to be missing, it may have been (1) left in a vehicle several hours before; and (2) left in any one of several vehicles.

### BRIEF SUMMARY OF THE PRESENT INVENTION

The present invention, an improved storage enclosure, has the ability to query individual objects within the enclosure in order to verify the presence or absence of each object. It also possesses the capability of wirelessly transmitting this verification information to a central control unit for further processing and maintenance coordination. The proper recording of these verifications will provide increased security against the likelihood of adverse incidents resulting from misplaced objects such as tools. In addition, the storage enclosure may be programmed to report its position, based on proximity to vehicles or other objects having a known position. The technologies necessary to accommodate these capabilities are varied, but the most practical are outlined herein:

The preferred embodiment of the improved storage enclosure has a radio frequency scanning device attached—designated as communications/scanning unit 10 (“com/scan unit” 10). This device is able to transmit and receive an RF signal throughout the enclosure. The particular characteristics of the device may require a plurality of antennae in a plurality of locations in order to accomplish a complete scan of the enclosures's contents, or this might be accomplished by making the drawer bottoms of plastic or fiberglass to allow free penetration of the RF signal. Attached or imbedded into the tools contained in the box, are Radio Frequency Identification Device (RFID) tags. These commercially available devices are silicon based integrated circuits that have the ability to store information, such as tool serial and part numbers, CTK number, etc., and transmit this information back when queried by the attached scanning device. The tags typically use no external power source, but are powered by the RF energy transmitted by the scanning device. Powered RFID tags are also available for performing more complex tasks. Information obtained by querying the RFID tags within the enclosure can then be wirelessly transmitted to a central control unit, where it is then used to monitor or expedite other activities.

In an aircraft maintenance environment, the enclosure is typically a toolbox (many varieties are commercially available). A technician would check the toolbox out of a tool storage facility. He or she would then transport it to an aircraft, open it, and remove tools during the course of completing the work. The toolbox would then be closed and secured at the completion of the job. The closing would initiate a verification scan of all tools within the box. Once a complete inventory of the tool kit is verified, the box then automatically transmits this verification to the central control unit, and the aircraft can be released from that particular maintenance order. This procedure will help insure that no tools are left within the aircraft, thereby reducing the likelihood of Foreign Object Damage or other vehicle endangerment from lost or misplaced tools. The enhanced monitoring capabilities of this device will also provide a deterrent to theft or sabotage.

The preferred embodiment would include memory means, which would allow the communications/scanning unit (“com/scan”) to store transactions when transported outside the transmit/receive range of the central control facility. When the kit is again within range of the facility, it would simply download the information. While this would be a more likely scenario with smaller tool kits, such functionality could be included on all enclosures.

Another embodiment consists of the same attached scanning arrangement and reporting characteristics, however the tools may have attached or embedded magnetic strips, individual magnetic segments, or visual bar code tags, which serve to register specific information to the scanning device.

Yet another embodiment consists of battery-powered transceivers on each tool to accomplish communication over a longer range, and possibility facilitate the location of a missing tool, or disable the tool if stolen.

Additional embodiments anticipate the use of biometric security devices to regulate access to the toolbox, specifically thumbprint readers and retinal scanners.

### BRIEF DESCRIPTION OF THE SEVERAL VIEWS OF THE DRAWINGS

FIG. 1 is a perspective view of a prior art tool box;

FIG. 2 is a ghost illustration of the prior art toolbox showing the placement of the components comprising the RFID scanning system and the security features;

FIG. 3 is a detailed view of the personal drawer lock, box lock, and drawer closure micro-switch installations;

FIG. 4 is a perspective view of a representative drawer, showing the drawer liner having recesses for specific objects cut into the surface of the liner;

FIG. 5 is a perspective view of a representative object, having engraved visual markings and an RFID tag;

FIG. 6 is a block diagram of the Communications/Scanning Unit, showing the keypad, card slot, and various connections and ports;

FIG. 7 is a detailed view of the Communications/Scanning Unit;

FIG. 8 is a perspective view of the installation of the Communications/Scanning Unit in the preferred embodiment;

FIG. 9 is a schematic view of the connections between the RFID and electronic components;

FIG. 10 is a functional block diagram showing the interaction of the installed electronic components in an anticipated embodiment;

FIG. 11 represents an embodiment of a ground level vehicle location system;

FIG. 12 is a functional block diagram showing the operation of the device in an anticipated environment.

### REFERENCE NUMERALS IN DRAWINGS

1 standard portable tool box

2 drawer

3 closeable lid

4 tool box key lock

5 separate drawer

6 separate drawer key lock

7 drawer locking mechanism

8a,b lock micro-switches

9a,b,c,d drawer closure micro-switches

10 communications/scanning unit

11 communications antenna

12 scanning antenna

13 drawer liner

14 RFID tag

15 representative tool

16 keypad

17 card reader

18 scanning antenna connector

19 communications antenna connector

20 external computer port

21 external power/battery charging port

22 stationary RFID scanners

23 representative vehicle

24 maintenance control facility

25 tool storage facility

### DETAILED DESCRIPTION OF THE INVENTION

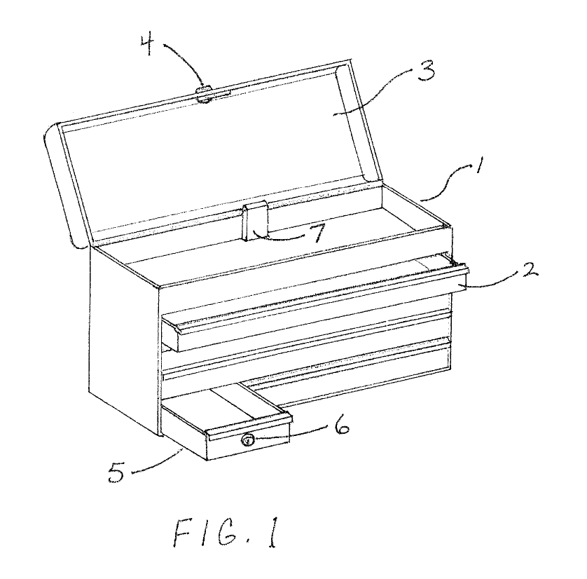

The present invention can be applied to many types of prior art enclosures. One typical application involves the addition of the present invention to a toolbox. FIG. 1 shows a typical prior art toolbox 1, having drawers 2, a closeable lid 3, a key lock 4, a separate drawer 5, a separate drawer key lock 6, and a drawer locking mechanism 7. As those familiar with such devices know, the operation of drawer locking mechanism 7 locks drawers 2 within the toolbox until and unless closeable lid 3 is opened. Thus, drawers 2 cannot be opened unless the user first unlocks key lock 4 and opens the lid.

Separate drawer 6 is locked and unlocked independently. It is typically used for the storage of the technician's personal items—such as keys, pocket knives, etc. As will be explained subsequently in more detail, it secures these items so that they do not accidentally fall out within the working area.

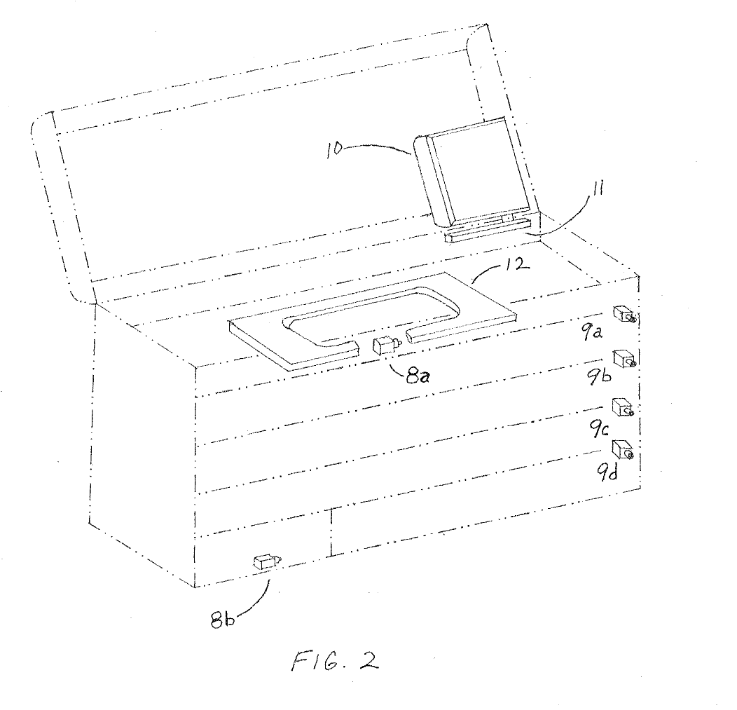

FIG. 2 shows the relative locations of components added by the present invention: two micro-switches 8a and 8b are located in proximity to the locking mechanism receivers for key lock 4 and separate drawer key lock 6. The locking of closeable lid 3 or separate drawer 5 will trigger micro-switches 8a and 8b respectively. The use of mechanical micro switches is not central to the present invention. Hall effect switches, optocouplers, or other sensing means known in the prior art could easily be substituted.

Microswitches 9a, 9b, 9c, and 9d are provided to sense the state (open or closed) of each drawer 2. Radio frequency communication/scanning unit 10 is installed in a convenient location, either inside or outside the toolbox. It is connected to communications antenna 11, which must generally be placed on the outside of the box to facilitate radio frequency communications with a central control unit or other external devices. One or more scanning antennae 12 are provided inside the box to transmit and receive signals to and from the RFID tags on the objects within the box.

Communication/scanning unit 10 can contain many items within its housing. It preferably contains memory means (such as storage chips or a small hard drive), a rechargeable power supply (such as a battery), and a programmable microprocessor for controlling the various functions carried out by the invention. As all these items are well understood in the art, they have not been illustrated in greater detail.

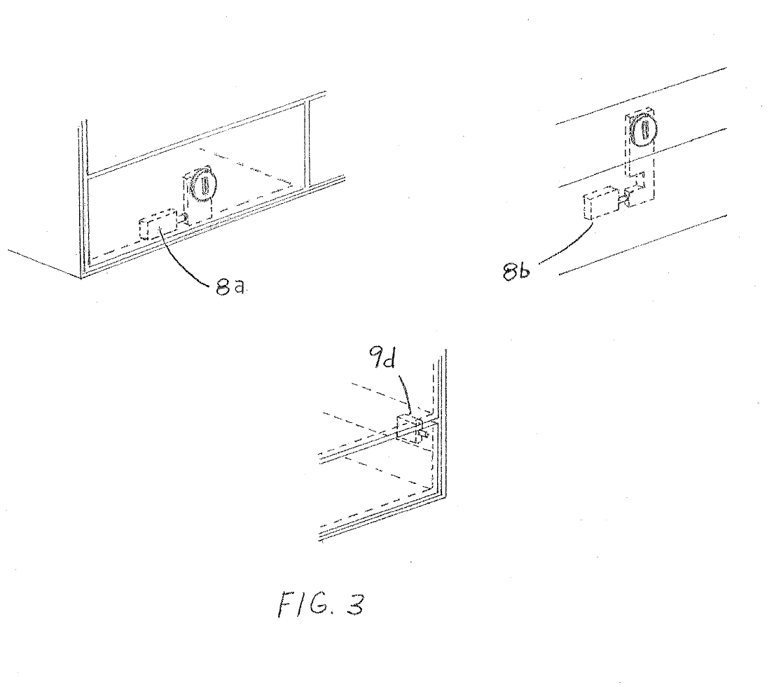

FIG. 3 illustrates in more detail the location of lock microswitches 8a and 8b, and a representative location for drawer-closure microswitch 9d. Each individual drawer in the toolbox, as well as the tray area directly under the lid, has a bottom made of a non-metallic material, of sufficient strength to bear the weight of objects placed inside. The use of a nonmetallic or other radio wave-permeable material allows the querying signals transmitted by scanning antenna 12 to permeate the interior of the box.

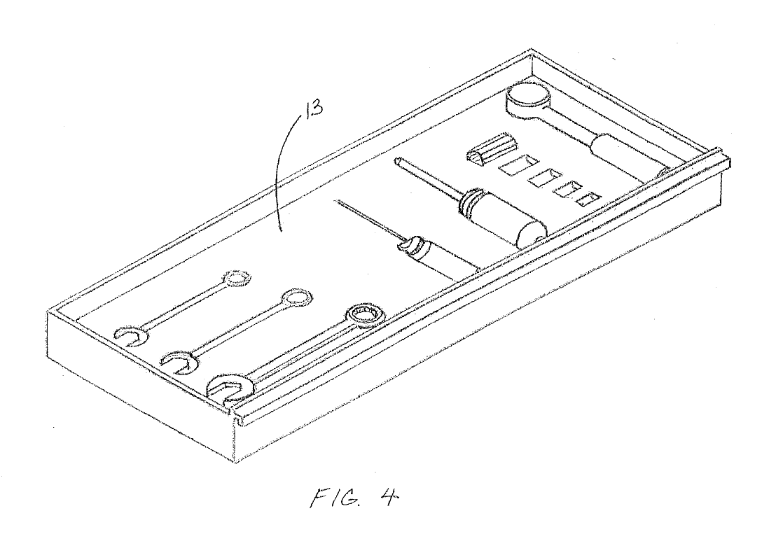

The tray and each drawer are preferably fitted with a liner constructed of two or more contrasting colored layers of laminated foam, having recesses cut into the surface in the exact shape of predetermined individual tools or objects. FIG. 4 shows a drawer with liner 13 installed. The absence of a tool or object from its position in the drawer is readily apparent due to the visibility of the uncovered lower layer of foam. The separate locking drawer does not require this special liner, as it is provided for the storage of miscellaneous personal items and is not opened in the area of maintenance activity.

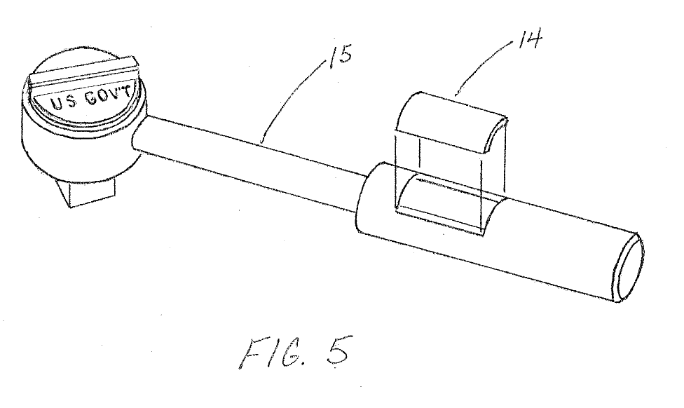

Each tool or object assigned to a particular toolbox has attached, embedded, or otherwise securely installed, a Radio Frequency Identification Device (“RFID”) tag 14, a version of which is illustrated in FIG. 5, attached to representative tool 15. The RFID tag contains information about that particular tool or object, such as its part number, serial number, and tool kit number (for cases in which the tool is assigned to a particular box—common in the aviation industry). Representative tool 15 may also bear identifying marks (e.g., “U S GOV'T”) indelibly etched into the surface for inventory and control.

Certain types of RFID tags can store rewritable information as well as a simple identification code. As an example, tools such as torque wrenches must be periodically recalibrated. Such tools have previously been provided with a sticker showing the calibration date and the period during which that calibration remains valid. An RFID tag is preferably substituted for this function. When queried, the RFID tag can supply the identifying information for the tool and its last date of calibration. The com/scan unit—either directly or via interaction with the database in the central control unit—checks that date against the present date and determines if the tool is available for use.

A second type of RFID tag 14 incorporates a small power source (sometimes called an “active” RFID tag). Such a tag is capable of receiving and transmitting signals over a much longer range than the passive tag. This type of tag may be applied to the more expensive tools. If the com/scan unit records such a tool as missing, then a location signal can be transmitted. The active RFID may then be used to actually locate the tool.

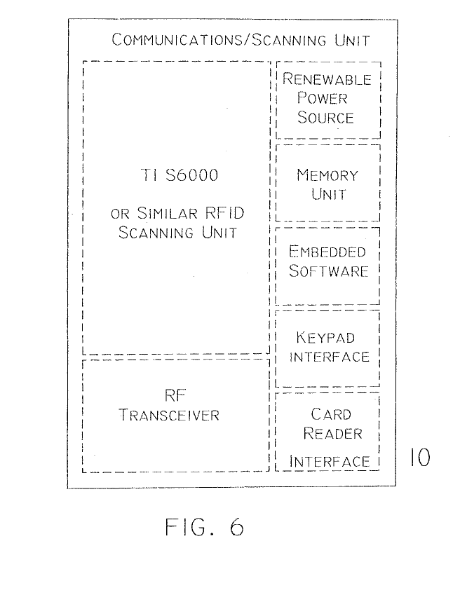

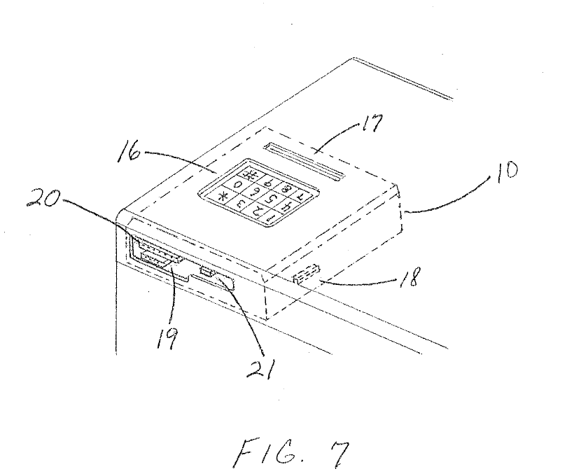

FIG. 6 is a block diagram of communication/scanning Unit 10. The com/scan unit 10, may be one of several commercially available RFID scanning devices such as the Texas Instruments S6000 Reader, combined with a conventional wireless RF transceiver, a memory for storage of digital information, a renewable power source, and installed software capable of translating the RF information into digital codes, and vice versa. FIG. 7 shows the installation of keypad 16 and card reader 17 for manual inputs. As shown in the view, keypad 16 is preferably accessible while the toolbox is still closed and locked. Com/scan unit 10 also includes scanning antenna connector 18 (for connecting to scanning antenna 12), and communications antenna connector 19 (for connecting to communications antenna 11). External power/battery charging port 21 connects to an external power source for charging the internal battery when the toolbox is in storage, or at other convenient times.

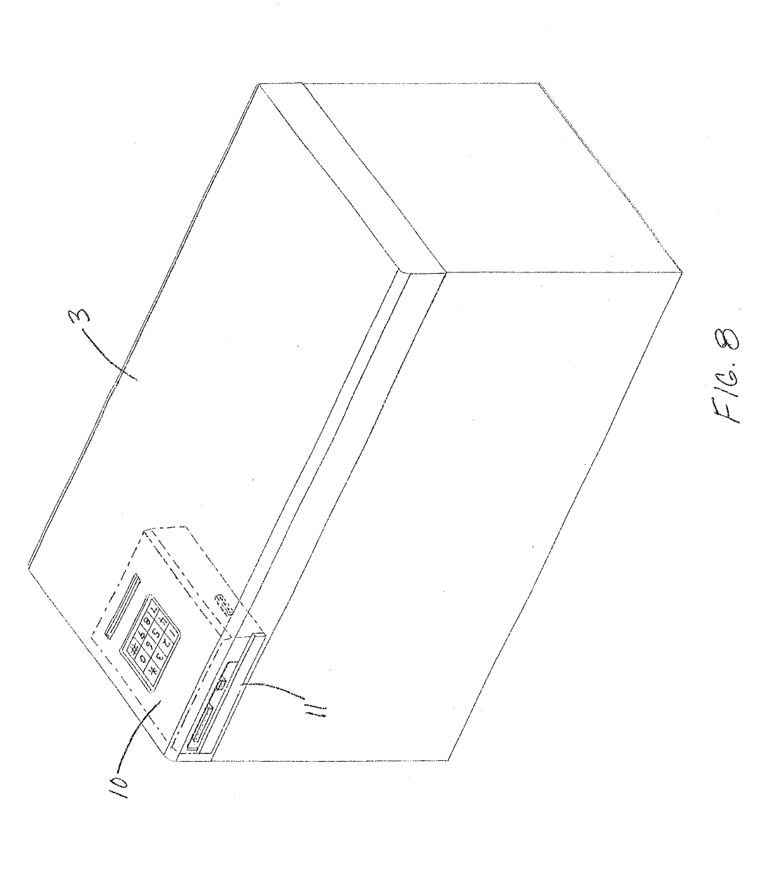

FIG. 8 shows com/scan unit 10 mounted in its preferred position—inside closeable lid 3. In this position it does not interfere with the placement of objects in the box's top tray. The conventional communications antenna 11 is mounted outside the lid, connecting thru to com/scan unit 10.

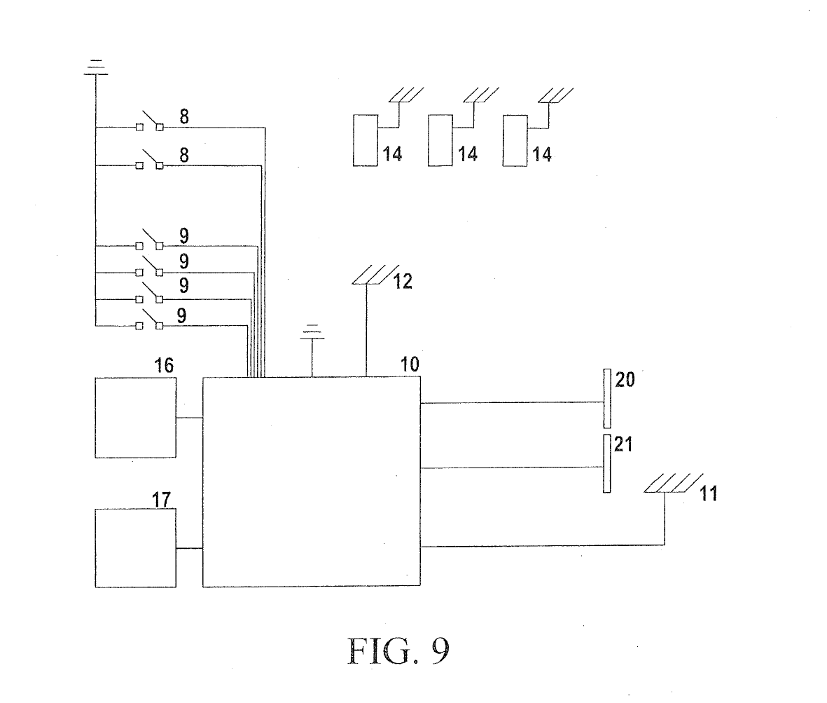

FIG. 9 illustrates the electrical connection of the RFID components within the device. The RFID components are arranged such that the opening of the box lid trips micro-switch 8a, which activates the com/scan unit 10 to begin registering the presence of the hand tools by communicating with each tool's individual RFID tag 14 through scanning antenna 12.

Tools are removed and replaced in the box, as needed, until the maintenance order is completed. All tools are visually accounted for, and the drawers and lid are then closed and locked. The closure of the drawers and lid activates microswitches 8a, and drawer closure microswitches 9a, 9b, 9c, and 9d. In the preferred embodiment, the closing of all these items initiates a tool inventory cycle. Com/scan unit 10 transmits an RF signal through scanning antenna 12. RFID tags 14 transmit a return RF signal which is received and analyzed by com/scan unit 10 in order to determine which tools are present and which tools—if any—are absent. Com/scan unit 10 can display the results of the inventory to the technician via display mounted on the toolbox itself, and can also transmit the results to the central control unit via communications antenna 11.

Local human interaction with com/scan unit 10 is accomplished thru keypad 16 and card reader 17, and computer links are established thru the external computer port 20 (shown in FIG. 7). Human interaction may also be provided through the remotely located central control unit, where system operators can access the data received from the toolbox and transmit signals to the toolbox indicating that the proper inventory has been received and that the toolbox is cleared for use on another job.

A display can be provided to the local technician and/or to a system operator back in maintenance control facility 24. This display can be configured to provide information concerning: (1) whether any tools are absent; (2) which specific tools are absent; and/or (3) which specific tools are present. The display could also provide simplified information to the technician—such as a flashing light or warning buzzer that could alter the technician that: (1) a tool is missing; (2) the toolbox is being removed from an area without proper authority; or (3) other appropriate information. A text display can also be provided.

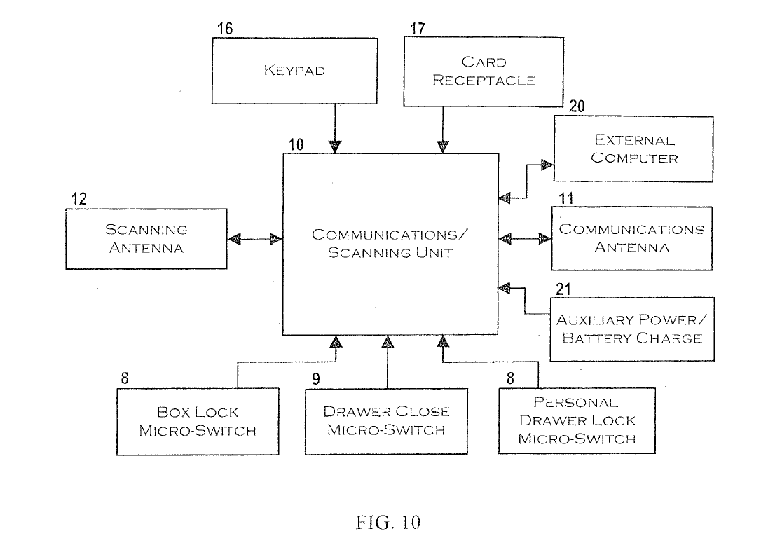

FIG. 10 is a functional block diagram illustrating the interaction of the RFID system components within the invention. Keypad 16, card reader 17, drawer closure micro-switches 9a, 9b, 9c, 9d, box and lock micro-switches 8a and 8b, and the external power/battery charge port 21, provide inputs to the communications/scanning unit 10. Scanning antenna 12, communications antenna 11, and external computer port 20 distribute and provide information, both to and from, communications/scanning unit 10.

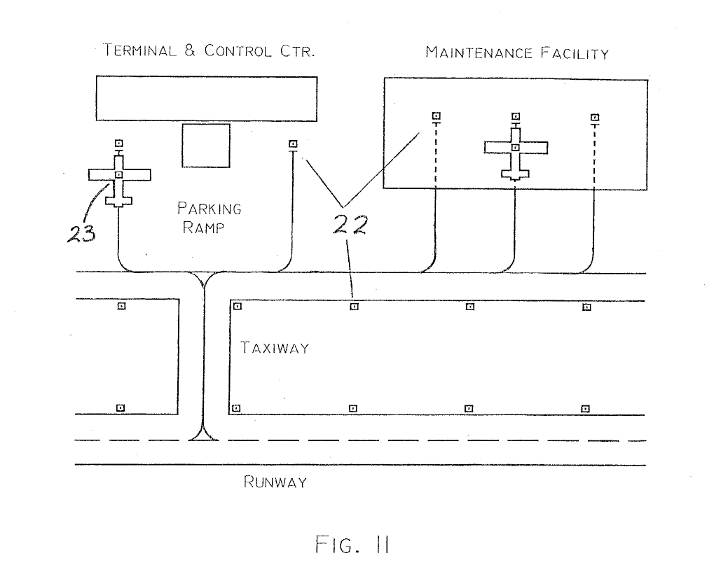

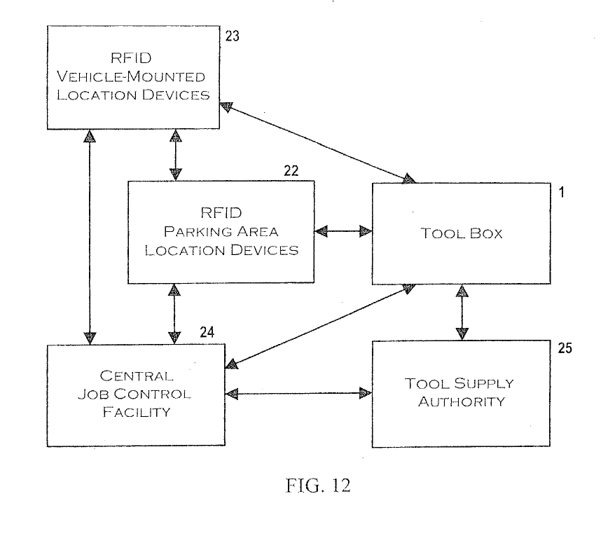

FIG. 11 illustrates a prior art vehicle location system using RFID scanners 22 installed in taxiways and parking areas, which interact with RFID tags on vehicles 23 (in this case aircraft) to provide location information. FIG. 12 is a functional block diagram illustrating the anticipated interaction of the invention in a vehicle maintenance environment. Toolbox 1, which incorporates the novel elements described previously, communicates with vehicle RFID tag 23, thereby establishing the toolbox's proximity to that particular vehicle. Com/scan unit 10 then transmits data to the central control unit indicating its proximity to the particular vehicle. The central control unit has information indicating the location of the particular vehicle from other sources (such as the prior art vehicle location system shown in FIG. 11). Thus, the central control unit can determine the approximate location of toolbox 1. The central control unit can also verify that the particular toolbox 1 is proximate the appropriate vehicle for the work that is scheduled.

Throughout this disclosure the term “central control unit” is used to refer to a remotely located radio receiver/transmitter connected preferably to a computer system. The central control unit keeps track of tool inventory, toolbox locations, vehicle locations, authorized technicians, repair order scheduling, etc. It may or may not be located in the same place where the toolboxes are stored when not in use (tool storage facility 25). It is in communication with this area, however. The toolboxes and work orders are generally controlled within maintenance control facility 24.

In operation, toolbox 1 (comprising the novel elements described previously) is maintained by maintenance control facility 24 as a Consolidated Tool Kit (“CTK”), generally stored within tool storage facility 25. The invention will require some periodic maintenance, such as the installation, charging, and/or replacement of batteries or other power source for the com/scan unit, and/or individual tools requiring separate power (such as the “active” RFID tags 14).

A particular CTK may be released from the responsibility of tool storage facility 25 for a specific maintenance order when a properly authorized technician accepts the responsibility by scanning a personal identification badge into card reader 17 on com/scan unit 10. Additional security for authorized technician identification can be provided by the installation of biometric identification devices, such as thumbprint readers or retinal scanners. Job information can be entered through the keypad 16, or from a coded card inserted into card reader 17. The information on the technician's badge, the job information, as well as the CTK's stored information regarding its contents, is transmitted to the central control unit for comparison to a central database. If the technician is listed as authorized to use that particular type of CTK, the possession and responsibility for the box will be transferred to the technician. At that time, all personal items not allowed in the maintenance area are removed and secured in separate drawer 5 prior to departure of technician to the job site.

Separate drawer 5 is preferably not accessible by the technician outside the tool storage facility 25, thereby reducing the likelihood that foreign items other than tools might find their way into the aircraft or vehicle. An alert will be activated by micro-switch 8b if separate drawer 5 is opened prior to the completion of the work order and subsequent securing of the tool kit and its contents. The alert signal can be displayed locally to the technician (such as via a flashing light, buzzer, or text display) and can be transmitted to the central control unit by Com/Scan unit 10. The access key to the drawer is located only in tool storage facility 25, and/or with the on-site maintenance supervisor.

The technician transports the box to the vicinity of the vehicle being maintained or repaired. The vehicle itself bears an RFID device for communicating with the box, and communicates with similar devices embedded at each particular vehicle parking location and throughout the perimeter of the airport, or throughout the maintenance facility for land based vehicles. The vehicle's location is ascertained by the central control unit and transmitted thereby to personnel within maintenance control facility 24. Subsequent communication between the invention and these embedded devices provides positional information for the toolbox that can be relayed to both the central maintenance control facility and the tool supply facility. This feature reduces the likelihood of the toolbox being used on the wrong vehicle, or in an area where some particular personnel danger exists. Software could also be installed in communications/scanning unit 10 to facilitate the recording of point-by-point location information in the unit memory for later security cross-checks.

Opening of the box lid activates com/scan unit 10 to begin registering the presence or absence of the hand tools by communicating with each tool's individual RFID tag. Communications/scanning unit 10 on board the toolbox communicates with the RFID location devices mentioned and relays that information to the central control unit. The toolbox may not be removed to another location prior to obtaining authorization from the central control unit. If the technician attempts to do so, an alarm is preferably sounded or otherwise provided on the toolbox itself, as well as in maintenance control facility 24.

Tools are removed and replaced in the box, as needed, until the maintenance order is completed. When equipped as described, the toolbox should require no input or interaction from the technician to record the dispensation and recovery of tools. Com/scan unit 10 can provide periodic data transmission to the central control unit regarding its location and the presence or absence of tools contained therein.

At job completion or the end of a work shift, the technician may seal the box by lock or other device, which initiates the inventory cycle. Com/scan unit 10 then transmits the results of the inventory cycle to the central control unit. This action signals the completion of maintenance activities by that technician (assuming all tools are present), and could speed up the release of a vehicle for service by timely communication of the toolbox's complete and secure status. If another technician should be required to resume the use of that particular kit on-site, a scan of his personal RFID badge into card reader 17 would seamlessly accomplish and record the transfer of the CTK to his or her responsibility, and further record that transaction with maintenance control facility 24, as well as tool storage facility 25.

Separate drawer 5 would only be opened in the presence of the on-site maintenance supervisor for transfer of personal items, otherwise the drawer would remain locked. If continued on-site use is not required, then the CTK would be returned to tool storage facility 25, where the return transfer and inventory verification is automatically recorded.

Not all applications are as exacting as the aviation industry. Some users may only wish to have an internal inventory control. In that incarnation, the invention would conduct an inventory query when closeable lid 3 is first opened. Memory means within the invention would then store an inventory of the tools present at that time. When closeable lid 3 is later closed, a second inventory query would be triggered. The results of the second query would then be compared with the results of the first and the user would be informed whether any tools are missing (as well as possibly being informed as to which tool is missing, etc.). This embodiment could easily be employed without the foam tray inserts. In other words, it could function with the tools being randomly placed in the drawers and trays of a conventional toolbox. Those skilled in the art will realize that the other embodiments disclosed could likewise function without the foam inserts.

Although the preceding descriptions have disclosed the invention in considerable detail, they should not be construed as limiting the scope of the invention but rather as disclosing the preferred embodiments. Accordingly, the scope of the invention should be construed according to the following claims, rather than by the examples given.

Having described our invention, we claim:

1. An object tracking system allowing a user to monitor the presence or absence of objects, comprising:
a. a portable enclosure, capable of being transported by a user to different locations without interrupting its operation, wherein said portable enclosure includes an enclosed interior and an access member moveable between an open position and a closed position so as to permit or deny access to said enclosed interior;
b. a radio frequency identification tag placed on each of a plurality of objects placed within said portable enclosure, capable of receiving a radio frequency signal and emitting a unique responsive radio frequency signal identifying the particular object to which it is affixed;
c. a communications/scanning unit affixed to said portable enclosure;
d. control means, connected to said communications/scanning unit, capable of causing the transmission of a radio frequency signal and receiving each of said unique responsive radio frequency signals, thereby determining whether each of said objects is present or absent; and
e. display means capable of providing information concerning whether any of said objects is absent.

2. An object tracking system as recited in claim 1, wherein said display means is further capable of providing said user information concerning which of said objects is absent.

3. An object tracking system as recited in claim 1, wherein said display means is further capable of providing information concerning which of said objects is present.

4. An object tracking system as recited in claim 1, further comprising an antenna within said enclosed interior, attached to said communications/scanning unit, wherein said antenna is capable of sending and receiving said radio frequency signals.

5. An object tracking system as recited in claim 1, further comprising:
a. a second type of radio frequency tag placed on objects requiring calibration, capable of receiving a radio frequency signal and emitting a first unique responsive radio frequency signal identifying the particular object to which it is affixed, and a second unique responsive radio signal providing information regarding the state of calibration of the object to which it is affixed; and
b. wherein said display means is further capable of providing information concerning the calibration of said objects requiring calibration.

6. An object tracking system as recited in claim 1, further comprising:
a. sensing means for sensing the state of said access member; and
b. wherein said control means transmits said radio frequency signal upon the opening or closing of said access member, so as to assess the presence or absence of said plurality of objects when said access member is opened or closed.

7. An object tracking system as recited in claim 6, wherein said control means further comprises memory means, capable of storing a first inventory of objects within said portable enclosure when said access member is opened, and capable of comparing said first inventory against a second inventory of objects within said portable enclosure when said access member is closed, in order to determine whether any object present when said access member was opened is not present when said access member is closed.

8. An object tracking system as recited in claim 7, wherein said display means is further capable of providing said user information concerning whether any of said objects which was present when said access member was opened is not present when said access member is closed.

9. An object tracking system as recited in claim 1, further comprising a central control unit, located remotely from said communications/scanning unit, and capable of two way radio communication with said communications/scanning unit, so that said communications/scanning unit can transmit information concerning the presence or absence of objects within said portable enclosure to said central control unit.

10. An object tracking system as recited in claim 1, further comprising locking means for locking said access member in said closed position.

11. An object tracking system as recited in claim 10, further comprising user identification interface means capable of automatically unlocking said locking means when a user presents an appropriate identification device to said user identification interface means.

12. An object tracking system as recited in claim 10, further comprising:
a. user identification interface means capable of transmitting a signal to said communications/scanning unit when a user presents an identification device to said user identification interface means;
b. lock actuation means for opening and closing said locking means;
c. a central control unit, located remotely from said communications/scanning unit, and capable of two way radio communication with said communications/scanning unit, so that said communications/scanning unit can transmit information concerning said user's identification device to said central control unit; and
d. wherein said central control unit thereafter checks said identification against a list of appropriate users and, if appropriate, sends a signal back to said communications/scanning unit directing said lock actuation means to open said locking means, thereby providing access for said user to said enclosed interior.

13. An object tracking system as recited in claim 9, further comprising a plurality of external location devices capable of two way radio communication with said communications/scanning unit, so that said communications/scanning unit can report its proximity to one of said plurality of external location devices to said central control unit, thereby informing said central control unit of the approximate location of said portable enclosure.

14. An object tracking system allowing a user to monitor the presence or absence of a plurality of objects, comprising:
a. an enclosure, including an enclosed interior and a lid moveable between an open position and a closed position so as to permit or deny access to said enclosed interior;
b. wherein said enclosure includes at least one drawer, capable of sliding between a closed position wherein its contents are held within said enclosed interior and an open position wherein its contents are accessible;
c. a radio frequency identification tag placed on each of a plurality of objects placed within said enclosure, capable of receiving a radio frequency signal and emitting a unique responsive radio frequency signal identifying the particular object to which it is affixed;
d. a communications/scanning unit affixed to said enclosure;
e. control means, connected to said communications/scanning unit, capable of causing the transmission of a radio frequency signal and receiving each of said unique responsive radio frequency signals, thereby determining whether each of said objects is present or absent; and
f. display means capable of providing said user information concerning whether any of said objects is absent.

15. An object tracking system as recited in claim 14, wherein said display means is further capable of providing information concerning which of said objects is absent.

16. An object tracking system as recited in claim 14, wherein said display means is further capable of providing information concerning which of said objects is present.

17. An object tracking system as recited in claim 14, further comprising:
a. wherein said at least one drawer includes side walls and a bottom wall, with said bottom wall being made of a material which does not significantly hinder the passage of radio waves; and
b. an antenna within said enclosed interior, attached to said communications/scanning unit, wherein said antenna is capable of sending and receiving said radio frequency signals.

18. An object tracking system as recited in claim 14, further comprising:
a. a second type of radio frequency tag placed on objects requiring calibration, capable of receiving a radio frequency signal and emitting a first unique responsive radio frequency signal identifying the particular object to which it is affixed, and a second unique responsive radio signal providing information regarding the state of calibration of the object to which it is affixed; and
b. wherein said display means is further capable of providing information concerning the calibration of said objects requiring calibration.

19. An object tracking system as recited in claim 14, further comprising:
a. sensing means for sensing the state of said lid; and
b. wherein said control means transmits said radio frequency signal upon the opening or closing of said lid, so as to assess the presence or absence of said plurality of objects when said lid is opened or closed.

20. An object tracking system as recited in claim 19, wherein said control means further comprises memory means, capable of storing a first inventory of objects within said portable enclosure when said lid is opened, and capable of comparing said first inventory against a second inventory of objects within said portable enclosure when said lid is closed, in order to determine whether any object present when said lid was opened is not present when said lid is closed.

21. An object tracking system as recited in claim 20, wherein said display means is further capable of providing said user information concerning whether any of said objects which was present when said lid was opened is not present when said lid is closed.

22. An object tracking system as recited in claim 14, further comprising a central control unit, located remotely from said communications/scanning unit, and capable of two way radio communication with said communications/scanning unit, so that said communications/scanning unit can transmit information concerning the presence or absence of objects within said portable enclosure to said central command unit.

23. An object tracking system as recited in claim 14, further comprising locking means for locking said lid and said at least one drawer in said closed position.

24. An object tracking system as recited in claim 23, further comprising user identification interface means capable of automatically unlocking said locking means when a user presents an appropriate identification device to said user identification interface means.

25. An object tracking system as recited in claim 23, further comprising:
a. user identification interface means capable of transmitting a signal to said communications/scanning unit when a user presents an identification device to said user identification interface means;
b. lock actuation means for opening and closing said locking means;
c. a central control unit, located remotely from said communications/scanning unit, and capable of two way radio communication with said communications/scanning unit, so that said communications/scanning unit can transmit information concerning said user's identification device to said central control unit; and
d. wherein said central control unit thereafter checks said identification against a list of appropriate users and, if appropriate, sends a signal back to said communications/scanning unit directing said lock actuation means to open said locking means, thereby providing access for said user to said enclosed interior.

26. An object tracking system as recited in claim 22, further comprising a plurality of external location devices capable of two way radio communication with said communications/scanning unit, so that said communications/scanning unit can report its proximity to one of said plurality of external location devices to said central control unit, thereby informing said central control unit of the approximate location of said portable enclosure.
